(19) United States
(12) Patent Application Publication
(10) Pub. No.: US 2023/0037670 A1
(43) Pub. Date: Feb. 9, 2023

(54) IMAGE ACQUISITION DEVICE AND IMAGE ACQUISITION METHOD USING THE SAME

(71) Applicant: VIEWORKS CO., LTD., Anyang-si (KR)

(72) Inventors: Hyun Suk JANG, Seongnam-si (KR); Yu Jung KANG, Anyang-si (KR); Min Gyu JIN, Seoul (KR)

(73) Assignee: VIEWORKS CO., LTD., Anyang-si (KR)

(21) Appl. No.: 17/881,952

(22) Filed: Aug. 5, 2022

(30) Foreign Application Priority Data
Aug. 6, 2021 (KR) 10-2021-0103819

(51) Int. Cl. G02B 21/36

(52) U.S. Cl. CPC G02B 21/367; G02B 21/361

(57) ABSTRACT

Provided are an image acquisition device which increases a small depth of field of an objective lens to acquire a high depth of field image and an image acquisition method using the same. The image acquisition device according to an exemplary embodiment of the present disclosure is an image acquisition device which acquires an image of a subject including an image collection unit; and an objective lens unit disposed below the image collection unit, and the image collection unit generates an image in which Z-axis signals are superposed within a range corresponding to a thickness of the subject, in an area to be captured of the subject.

### CROSS-REFERENCE TO RELATED APPLICATIONS

This application claims priority to and the benefit of Korean Patent Application No. 10-2021-0103819 filed in the Korean Intellectual Property Office on Aug. 6, 2021, the entire contents of which are incorporated herein by reference.

### BACKGROUND

### Field

The present disclosure relates to an image acquisition device and an image acquisition method using the same, and more particularly, to an image acquisition device which acquires a high depth of field image and an image acquisition method using the same.

### Description of the Related Art

A microscope is an instrument which magnifies and observes microscopic objects or microorganisms which are difficult to be observed with the human eye.

A scan device (for example, a slide scanner) which interworks with the microscope is a device which automatically scans one or a plurality of slides to store, observe, and analyze images. A demand for a slide scanner which is an example of the scan device is increased for the purpose of pathological examination.

When a digital slide image is acquired using a slide scanner, it is important to increase a precision of an image focus. Generally, a tissue sample for acquiring a digital slide image has a thickness of approximately 4 μm and a cell sample has a thickness of several tens of micrometers.

Here, when the tissue sample or the cell sample is scanned, it is important to increase a depth of field. However, when the magnification of the objective lens is enlarged to 20 to 40 times for this reason, the depth of field of the objective lens is approximately 1 μm, so that there is a problem in that the depth of field is smaller than the thickness of the tissue sample.

As described above, in order to solve the problem in that the depth of field of the objective lens is smaller than the thickness of the tissue sample, in the related art, several images having different focus heights for one field of view are captured to capture a subject which is thicker than the depth of field (approximately, 1 μm) of the objective lens as described above. Next, images are processed to recombine most focused parts of each image to generate one high depth of field image.

However, the related method has a disadvantage in that the same area is captured several times to acquire a single high depth of field image so that it takes a lot of time.

Specifically, in the case of equipment for capturing a whole slide image (WSI) of the subject, such as the above-described slide scanner, it was necessary to scan hundreds to thousands of times with a high magnification to generate a Z-stack image of a single slide WSI. Therefore, there was a problem in that it was practically impossible to scan the WSI by the Z-stack imaging method of the related art.

### RELATED ART DOCUMENT

### Patent Document

Korean Unexamined Patent Application Publication No. 10-2020-0047971

### SUMMARY

An object of the present disclosure is to provide an image acquisition device which is capable of acquiring a high depth of field image by increasing a small depth of field of an objective lens and an image acquisition method using the same.

According to an aspect of the present disclosure, an image acquisition device is an image acquisition device which acquires an image of a subject including an image collection unit; and an objective lens unit disposed below the image collection unit, wherein the image collection unit generates an image in which Z-axis signals are superposed within a range corresponding to a thickness of the subject, in an area to be captured of the subject.

Desirably, the area to be captured includes a first image capturing area in which the first image is captured and a second image capturing area which is an area to be captured of the subject adjacent to the first image capturing area.

Desirably, the image collection unit is configured to generate a first image in which the Z-axis signals are superposed within the range corresponding to the thickness of the subject in the first image capturing area and generate a second image in which the Z-axis signals are superposed within the range corresponding to the thickness of the subject in the second image capturing area.

Desirably, the image acquisition device further includes: a Z-axis position reception unit which receives a thickness of the subject, a Z-axis height position in the area to be captured, and a focal position of the objective lens unit; an image processing unit which matches the first image and the second image to generate a whole slide image; and a display unit which outputs the generated whole slide image.

Desirably, the image collection unit is a TDI sensor including a plurality of stages.

Desirably, the image collection unit is disposed with respect to the subject such that the plurality of stages is inclined with respect to a movement direction of the subject at a predetermined angle, and continuously acquire different Z-axis signals formed at different focus heights in each stage within the range corresponding to the thickness of the subject and acquire the image in which the Z-axis signals are superposed by summating the different Z-axis signals for each stage.

Desirably, the image collection unit is an area sensor including a variable focus lens.

Desirably, the image collection unit is configured to allow the variable focus lens to continuously change a focal distance within the range corresponding to the thickness of the subject to acquire different Z-axis signals and summate the different Z-axis signals to acquire an image in which Z-axis signals are superposed.

Desirably, the image acquisition device further includes an image processing unit including a filtering unit which performs a low frequency removal filtering process on the image in which the Z-axis signals are superposed.

Desirably, the image processing unit includes: a filtering unit which performs a low frequency removal filtering process on the first image and the second image; and an image matching unit which stitches the first image and the second image which are subjected to the low frequency removal filtering process to generate the whole slide image.

Desirably, the image acquisition device further includes: a stage unit which is disposed below the objective lens unit and on which the subject is disposed; and an illumination unit which is disposed below the stage unit and irradiates a light onto the subject.

Desirably, the second image at least partially overlaps the first image.

According to another aspect of the present disclosure, an image acquisition method includes: placing a first image capturing area of a subject on an FOV of an objective lens unit; receiving a thickness of the subject, a Z-axis height position of the subject in the first image capturing area, and a focal position of the objective lens unit; generating a first image in which Z-axis signals are superposed within a range corresponding to the thickness of the subject in the first image capturing area; and performing a low frequency removal filtering process on the generated first image.

Desirably, the image acquisition method further includes: placing a second image capturing area of the subject adjacent to the first image capturing area on an FOV of the objective lens unit by moving the subject; receiving a Z-axis height position of the subject in the second image capturing area; generating a second image in which Z-axis signals are superposed within the range corresponding to the thickness of the subject in the second image capturing area; performing a low frequency removal filtering process on the generated second image; and generating a whole slide image by stitching the first image and the second image.

Desirably, the second image at least partially overlaps the first image.

According to the present disclosure, Z-axis image information is acquired to be superposed as a single image to acquire a high depth of field image while reducing a capturing time and simplifying a data quantity and an image processing amount.

### BRIEF DESCRIPTION OF THE DRAWINGS

FIG. 1 is a view illustrating an image acquisition device according to an exemplary embodiment of the present disclosure;

FIG. 2 is a view illustrating an image collection unit provided in an image acquisition device according to an exemplary embodiment of the present disclosure;

FIG. 3A and FIG. 3B are views illustrating a process of acquiring an image using an image acquisition device according to an exemplary embodiment of the present disclosure;

FIG. 4 is a view illustrating an image acquisition device according to a second exemplary embodiment of the present disclosure;

FIG. 5A and FIG. 5B are views illustrating a process of acquiring an image using an image acquisition device according to a second exemplary embodiment of the present disclosure;

FIG. 6 is a flowchart illustrating an image acquisition method using an image acquisition device according to the present disclosure; and

FIG. 7 is a view illustrating an example of an image acquired using an image acquisition device according to the present disclosure.

### DETAILED DESCRIPTION OF THE EMBODIMENT

Hereinafter, exemplary embodiments of the present disclosure will be described in detail with reference to the accompanying drawings. In the figures, it should be noted that even though the parts are illustrated in different drawings, it should be understood that like reference numerals refer to like parts of the present invention throughout the several figures of the drawing. Furthermore, when it is judged that specific description on known configurations or functions related in the description of the present invention may unnecessarily obscure the essentials of the present invention, the detailed description will be omitted. Further, hereinafter, exemplary embodiments of the present disclosure will be described. However, it should be understood that the technical spirit of the invention is not restricted or limited to the specific embodiments, but may be changed or modified in various ways by those skilled in the art to be carried out.

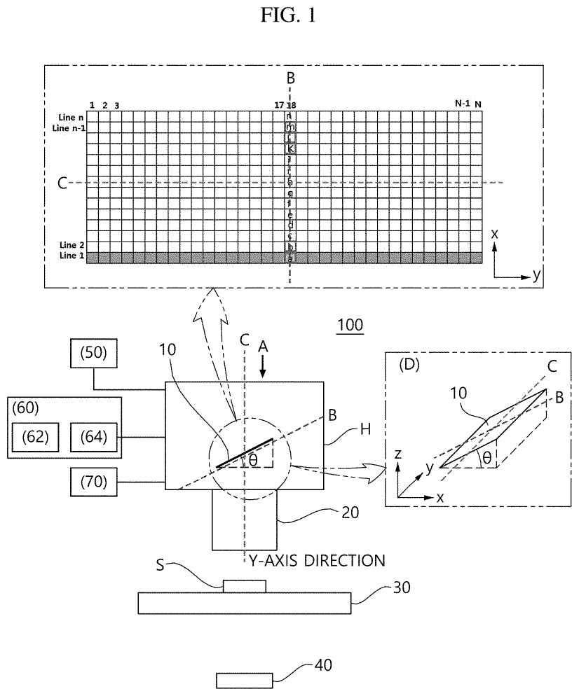

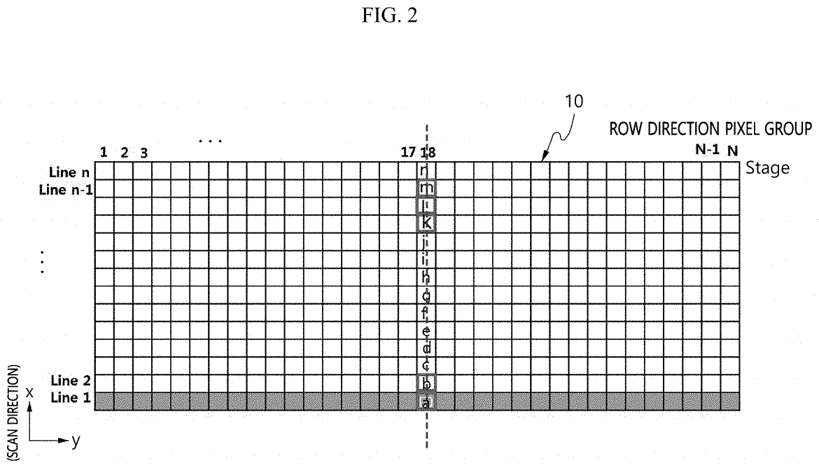

FIG. 1 is a view illustrating an image acquisition device 100 according to an exemplary embodiment of the present disclosure and FIG. 2 is a view illustrating an image collection unit 10 provided in an image acquisition device 100 according to an exemplary embodiment of the present disclosure. At this time, in FIG. 1, an enlarged view of the image collection unit 10 illustrates a state of the image collection unit 10 seen from a direction A and a portion D of FIG. 1 illustrates only the image collection unit 10 on a 3D coordinate system.

Referring to FIG. 1, the image acquisition device 100 according to the exemplary embodiment of the present disclosure includes the image collection unit 10 provided in a housing (barrel) H, an objective lens unit 20 which is disposed below the image collection unit 10 and is fixed to the housing H, and a stage unit 30 which is disposed below the objective lens unit 20. A subject S is disposed on the stage unit 30.

The objective lens unit 20 controls a distance from the subject S or the stage unit 30 according to a control signal of a separate driving control unit (not illustrated) and the stage unit 30 moves in an X-axis, Y-axis, or Z-axis according to a control signal of a separate driving control unit (not illustrated).

Generally, a tissue sample for acquiring a digital slide image has a thickness of approximately 4 μm and a cell sample has a thickness of tens of micrometers. For example, a thickness of the subject S may be three times to fifty times a depth of field of the objective lens unit 20.

For example, the image acquisition device 100 may be an optical microscope, but is not limited thereto.

In the image acquisition device 100 according to the exemplary embodiment of the present disclosure, the image collection unit 10 is a TDI (Time Delay Integration) sensor, which is a type of line scan sensor that integrates the amount of light while delaying time, and is configured by a plurality of stages and converts an optical signal into an electrical signal to acquire image information.

Generally, the TDI sensor captures the same target in each stage and accumulates a signal output from each stage to generate one line image. As described above, in the general TDI sensor, the signal is accumulated in each stage so that the effect of increasing of the exposure time is obtained as much as the number of stages. Therefore, a bright image may be obtained so that the more the number of stages, the faster the scanning. Accordingly, generally, the TDI sensor may be used for a system which quickly scans a target in a dark environment or having a low signal to generate an image.

According to the above-described characteristic of the TDI sensor, in the existing system, the optical system needs to be configured such that pixels in a short direction in each stage accumulate a signal of the same target so that focus heights between pixels in the short direction of each stage and a target to be captured are disposed to keep the same all the time. If the pixels in the short direction of the stage inevitably cause a difference in the focus height from the target to be captured, the number of stages is minimized to less than 10 so that the difference in focus height can be minimized. However, the image collection unit 10 in the image acquisition device 100 according to the exemplary embodiment of the present disclosure configures the TDI sensor such that a focus height between the pixels in the short direction of each stage and the target to be captured has a deviation for every pixel. Therefore, unlike the general TDI sensor of the related art, one line image has a superposed signal with various focus heights (Z-axis direction).

Referring to FIGS. 1 and 2, the image collection unit 10 may be configured by a plurality of stages as described above, and for example, may be configured by at least 10 stages. At this time, in FIG. 1, the line “B” indicates a “row direction (short direction) of the image collection unit 10 and the line “C” indicates a “column direction (long direction) of the image collection unit 10.

For example, as illustrated in FIGS. 1 and 2, the image collection unit 10 is configured to have N “row direction pixel groups” from 1 to N and n stages (“column direction pixel group”) from a first line to a n-th line.

At this time, each “row direction pixel group” may have n pixels and each stage may have N pixels.

Further, the image collection unit 10 may be disposed with respect to the subject S (or the stage unit 30) such that the plurality of stages is inclined with respect to the movement direction (X-axis direction, scan direction) of the subject S (or the stage unit 30) at a predetermined angle θ.

For example, the range of the predetermined angle θ at which the stage is inclined with respect to the movement direction of the subject S may be an acute angle range of more than 0° and less than 90° with respect to the movement direction (scan direction) of the subject S as illustrated in FIG. 1, or an obtuse angle range of more than 90° and less than 180° even though it is not illustrated in the drawing.

At this time, when the scan is performed from the left side to the right side of the subject S, if the range of “the predetermined angle θ” at which the stage is inclined with respect to the movement direction of the subject S is an acute angle range as illustrated in FIG. 1, the capturing may be performed from a low Z-axis focus height of the stage to a high Z-axis focus height. Further, if the range of “the predetermined angle θ” at which the stage is inclined with respect to the movement direction of the subject S is an obtuse angle range, the capturing may be performed from a high Z-axis focus height of the stage to a low Z-axis focus height. At this time, the scan direction may be from the right side to the left side of the subject S.

In the present disclosure, even though it is described that the X-axis direction is the scan direction (a movement direction of the subject S (or the stage unit 30)), the scan direction is not limited to the X-axis direction.

Further, referring to the portion D of FIG. 1 and FIG. 2, the plurality of “row direction pixel groups” of the image collection unit 10 may be disposed with respect to the subject S (or the stage unit 30) to be inclined with respect to the movement direction (X-axis direction) of the subject S (or the stage unit 30) at the predetermined angle θ. All the “row direction pixel groups” which are perpendicular to the Y axis and are inclined with respect to movement direction (X-axis direction) of the subject S (or the stage unit 30) at the predetermined angle θ may be disposed in the Y axis direction which is perpendicular to the X axis direction, in parallel.

The image collection unit 10 provided in the image acquisition device 100 according to the exemplary embodiment of the present disclosure is disposed with respect to the subject S (or the stage unit 30) such that the plurality of stages is inclined with respect to movement direction of the subject S (or the stage unit 30) at the predetermined angle. Therefore, pixels (for example, a to n pixels) in the same row direction pixel group (for example, an eighteenth row direction pixel group in FIGS. 1 and 2) in each stage (first line to n-th line) for the subject S may have different focus heights.

Accordingly, when the image collection unit 10 configured as described above is used, within a range corresponding to the thickness of the subject S, each stage (first line to n-th line) continuously acquires different Z-axis signals formed at different focus heights in each stage and summates different Z-axis signals corresponding to each stage to generate one line scan image in which these signals are superposed (specifically, the line scan image is an image on an XY plane formed with respect to different Z-axis focus heights).

Further, the image collection unit 10 may continuously capture the subject S while slightly moving the focal point in a vertical direction so as to sense an approximate height of the subject S during the scanning of the subject S.

Referring to FIG. 1 again, the image acquisition device 100 according to the exemplary embodiment of the present disclosure may further include an illumination unit 40, a focal position reception unit 50, an image processing unit 60, and a display unit 70.

According to the exemplary embodiment, the illumination unit 40 is disposed below the stage unit 30 and irradiates a light onto the subject S. However, the placement of the illumination unit 40 is not limited as illustrated in FIG. 1, and the illumination unit 40 may be disposed above the stage unit 30.

As an example, in the image acquisition device 100 according to the exemplary embodiment of the present disclosure, the illumination unit 40, the stage unit 30, the subject S, the objective lens unit 20, and the image collection unit 10 are disposed in this order in a vertical direction with respect to an optical axis of the light incident from the illumination unit 40.

The focal position reception unit 50 receives a thickness of the subject S, the Z-axis height position of the subject S, and a focal position of the objective lens unit 20.

Further, as an example, the focal position reception unit 50 may include a focus camera or a laser sensor.

At this time, as an example, the measurement of the Z-axis height position of the subject S in the focal position reception unit 50 is performed by an objective lens Z-axis position analysis method based on an image by the focus camera or a laser distance measurement method by a laser sensor, but is not limited thereto.

The high magnification microscope of the related art requires a detailed focus height so that when only the laser sensor is used, accurate measurement is not easy. However, according to the present disclosure, images with various focus heights can be obtained so that even though the laser distance measurement method by a laser sensor is used, an image with an accurate focus may be acquired.

When a size of the subject S disposed on the stage unit 30 is larger than an area which is captured by the image collection unit 10 at one time, the image collection unit 10 scans the area to be captured of the subject S (an area which can be captured by the image collection unit 10 at one time) to sequentially generate images in which Z-axis signals are superposed and the image processing unit 60 performs a stitching process on the adjacent images to generate a whole slide image.

At this time, the image collection unit 10 and the image processing unit 60 may be sequentially or simultaneously operated.

In the meantime, when the size of the subject S disposed on the stage unit 30 is equal to or similar to the area which is captured by the image collection unit 10 by one shot, the area to be captured of the subject S may be considered as a whole region of interest (ROI) of the subject S. For example, the region of interest of the subject S may refer to a region of the subject to be captured by the user.

When the subject S is larger than an area which is captured by the image collection unit 10 at one time, after placing the area to be captured of the subject S in the FOV of the objective lens unit 20, a first image in which Z-axis signals are superposed may be generated by the image collection unit 10.

At this time, like the image acquisition device 100 according to the exemplary embodiment of the present disclosure, when the image collection unit 10 is configured by the TDI sensor, the FOV of the objective lens unit 20 may refer to a perpendicular viewing angle of the scan direction.

Next, after placing an area to be captured of the subject S (a second image capturing area) adjacent to the above-described area to be captured (for example, a first image capturing area in which the first image is captured) in the FOV of the objective lens unit by moving the subject S according to the driving of the stage unit 30, a second image in which the Z-axis signals are superposed may be generated by the image collection unit 10. At this time, for smooth image matching, the second image may be captured to at least partially overlap the first image.

In the image acquisition device 100 according to the exemplary embodiment of the present disclosure, the first image may refer to an image obtained by adding line images generated by the capturing of the image collection unit 10 until the stage unit 30 on which the subject S is disposed stops after starting the movement to the scan direction. The second image may an image obtained by adding line images generated by the capturing of the image collection unit 10 while the stage unit 30 starts the movement again and then stops after completing the capturing of the first image. At this time, in order to move the subject S between image capturing, the stage unit 30 may move separately from the capturing of the image collection unit 10.

Further, the image capturing may be repeated until the whole region of interest (ROI) of the subject S is captured. For example, during the subsequent image capturing (for example, a third image captured for a third image capturing area and a fourth image captured for a fourth image capturing area), the capturing may be performed so as to at least partially overlap the previous captured image. For example, the third image may be captured so as to at least partially overlap the second image and the fourth image may be captured so as to at least partially overlap the third image.

The image processing unit 60 may generate the whole slide image by matching the first image and the second image.

To be more specific, the image processing unit 60 may include a filtering unit 62 which performs a low frequency removal filtering process on the first image and the second image and an image matching unit 64 which stitches the first image and the second image to generate the whole slide image.

For example, the filtering unit 62 uses a high pass filter to perform the low frequency removal filtering process on the first image and the second image.

Further, as described above, the first image may at least partially overlap the second image so that when the image matching unit 64 stitches the first image and the second image, in order to remove the difference in the overlapping portion of the first image and the second image, the image matching unit 64 performs the stitching process to make a color, a brightness, a contrast, and a resolution equal to each other as much as possible in the overlapping portion of the first image and the second image.

The display unit 70 may output the whole slide image is generated by the image matching unit 64.

In the meantime, when there is no image other than the first image, the low frequency removal filtering process is performed only on the first image by the filtering unit 62 of the image processing unit 60 without performing an additional image stitching process by the image matching unit 64 of the image processing unit 60 to generate an image.

To be more specific, when there is no image other than the first image, the area to be captured of the subject S may correspond to the whole region of interest ROI. The image collection unit 10 generates an image (the first image) in which the Z-axis signals are superposed within a range corresponding to the thickness of the subject S in the area to be captured of the subject S by one shot. Further, the filtering unit 62 performs the low frequency removal filtering process on the image in which the Z-axis signals are superposed.

At this time, the display unit 70 may output the image filtered by the filtering unit 62 in which the Z-axis signals are superposed.

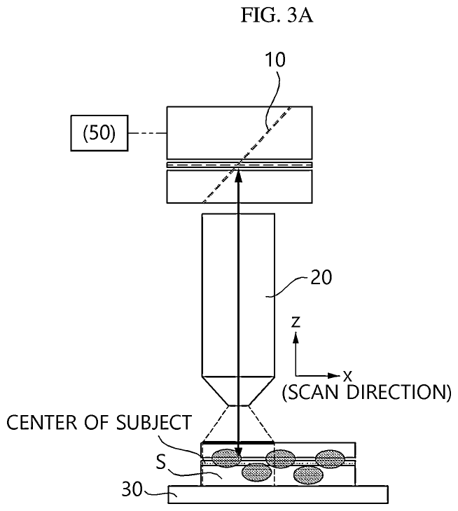

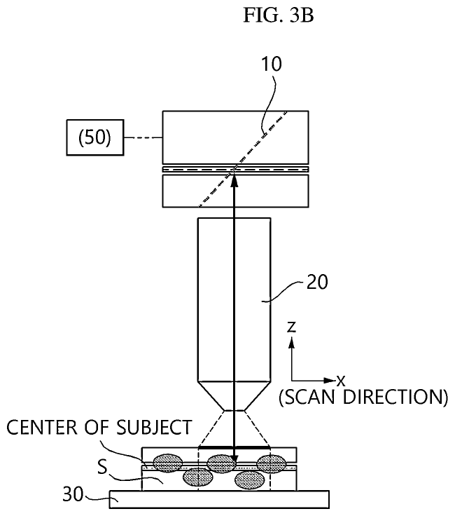

FIG. 3A and FIG. 3B are views illustrating a process of acquiring an image using an image acquisition device 100 according to an exemplary embodiment of the present disclosure. To be more specific, FIG. 3A illustrates a process of acquiring the first image by placing the subject S in the FOV of the objective lens unit 20 and FIG. 3B illustrates a process of acquiring the second image by placing an area adjacent to an area of the subject S where the first image is acquired in the FOV of the objective lens unit 20.

Referring to FIG. 3A and FIG. 3B, the process of acquiring an image using an image acquisition device 100 according to an exemplary embodiment of the present disclosure is as follows.

First, as illustrated in FIG. 3A, the area to be captured of the subject S is located in the FOV of the objective lens unit 20 according to the driving of the stage unit 30. At this time, the area to be captured may be designated by the user by means of a separate input interface (not shown) connected to the image acquisition device 100 and the stage unit 30 is driven by designating the area to be captured using the input interface so that the area to be captured of the subject S is located in the FOV of the objective lens unit 20.

Next, as illustrated in FIG. 3A, the focal position reception unit 50 receives a thickness of the subject S, the Z-axis height position of the subject S in the area to be captured, and a focal position of the objective lens unit 20.

For example, as illustrated in FIG. 3A, when the focal position reception unit 50 receives the thickness of the subject S, thickness information to be input may be less than 90% of the entire thickness of the subject S. When the thickness of the subject S is halved vertically with respect to the center of the subject S, the upper 45% thickness and the lower 45% thickness from the center of the subject S may be input by the focus position reception unit 50. However, the thickness of the subject S which is input to the focal position reception unit 50 is not limited to the above description so that the thickness may be much smaller than 90% of the entire thickness of the subject S or may be 100% of the entire thickness of the subject S according to the characteristic of the subject S.

Further, in the image acquisition method using the image acquisition device 100 according to the exemplary embodiment of the present disclosure, it has been described that after locating the area to be captured of the subject S in the FOV of the objective lens unit 20 according to the driving of the stage unit 30, the thickness of the subject S, the Z-axis height position of the subject S, and the focal position of the objective lens unit 20 are input by the focal position reception unit 50. However, the present disclosure is not limited thereto so that the process of inputting the thickness of the subject S, the Z-axis height position of the subject S, and the focal position of the objective lens unit 20 by the focal position reception unit 50 may be performed first.

Next, as illustrated in FIG. 3A, in the area to be captured of the subject S, an image in which the Z-axis signals are superposed within the range corresponding to the thickness of the subject S may be generated by the image collection unit 10.

Referring to FIGS. 1 and 2 again, as described above, since the plurality of stages are disposed with respect to the subject S (or the stage unit 30) to be inclined with respect to the movement direction of the subject S (or the stage unit 30) at a predetermined angle, the image collection unit 10 may have different focus heights in each stage (first line to n-th line).

Accordingly, the image collection unit 10 may acquire different Z-axis signals formed by different focus heights of the stages (first line to n-th line) within a range corresponding to the thickness (for example, approximately 90% of the entire thickness of the subject S) of the subject S input by the focal position reception unit 50. Accordingly, when the Z-axis signal values for the stages (first line to n-th line) are summated by the image collection unit 10, a signal image in which various focus heights are superposed may be generated as one line scan image.

Next, the low frequency removal filtering process may be performed on the image generated by the image collection unit 10, by the filtering unit 62 provided in the image processing unit 60.

In the image acquisition method using the image acquisition device 100 according to the exemplary embodiment of the present disclosure, when there is no image other than the above-described first image, a separate image stitching process by the image matching unit 64 provided in the image processing unit 60 as described above may not be performed. When there is no image other than the first image, the image processing unit 60 stores the first image which is generated by the image collection unit 10 and is subjected to the low frequency removal filtering process by the filtering unit 62 and the display unit 70 displays the generated first image to the user.

In the meantime, when there is another area to be captured in the subject S other than the above-described area to be captured (for example, the first image capturing area in which the first image is captured), as illustrated in FIG. 3B, the subject S moves according to the driving of the stage unit 30 to place the area to be captured of the subject S (a second image capturing area) adjacent to the first image capturing area in the FOV of the objective lens unit 20. For example, the second image capturing area may at least partially overlap the first image capturing area.

Similar to the first image capturing area, the second image capturing area is also designated by the user by means of the above-described input interface. As the second image capturing area is designated by the input interface, the stage unit 30 is driven to locate the second image capturing area of the subject S in the FOV of the objective lens unit 20.

Next, as illustrated in FIG. 3B, the Z-axis height position of the subject S in the second image capturing area may be received by the focal position reception unit 50.

Next, as illustrated in FIG. 3B, in the second image capturing area, a second image in which the Z-axis signals are superposed within the range corresponding to the thickness of the subject S may be generated by the image collection unit 10.

At this time, like the above-described first image, the second image may be an image obtained by generating a signal image in which various focus heights are superposed as one line scan image.

Next, the low frequency removal filtering process may be performed on the second image generated by the image collection unit 10, by the filtering unit 62 provided in the image processing unit 60. The image acquisition method using the image acquisition device 100 according to the exemplary embodiment of the present disclosure may be repeatedly performed until there is no more area adjacent to the first image capturing area and the second image capturing image or there is no area to be captured which has not been captured for the subject S (until the whole region of interest ROI of the subject S is captured).

Next, the first image and the second image are subjected to the stitching process by the image matching unit 64 provided in the image processing unit 60 to generate the whole slide image. As described above, the second image capturing area may at least partially overlap the first image capturing area so that when the image matching unit 64 stitches the first image and the second image, in order to remove the difference in the overlapping portion of the first image and the second image, the image matching unit 64 performs the stitching process by making colors, brightnesses, contrasts, and resolutions equal to each other in the overlapping portion of the first image and the second image as much as possible.

Next, the display unit 70 displays the whole slide image generated by stitching the first image and the second image by the image matching unit 64 to the user.

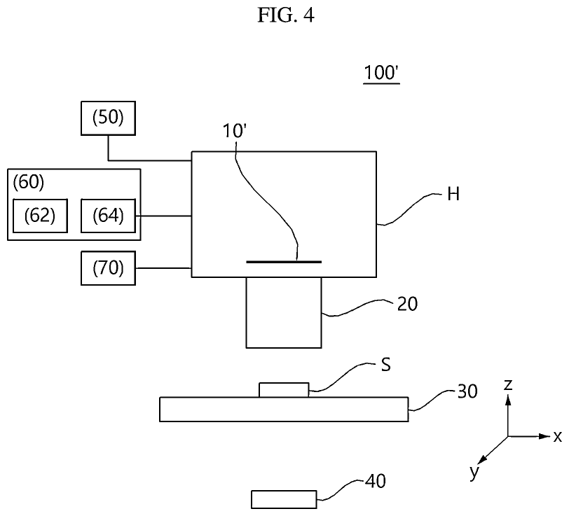

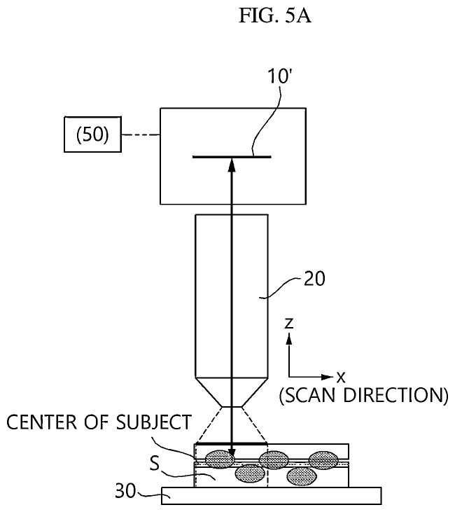

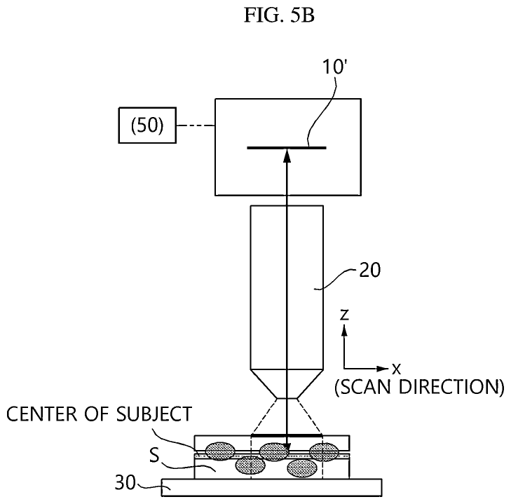

FIG. 4 is a view illustrating an image acquisition device 100′ according to a second exemplary embodiment of the present disclosure and FIG. 5A and FIG. 5B are views illustrating a process of acquiring an image using an image acquisition device 100′ according to a second exemplary embodiment of the present disclosure. To be more specific, FIG. 5A illustrates a process of acquiring the first image by placing a first image capturing area of the subject S in the FOV of the objective lens unit 20 and FIG. 5B illustrates a process of acquiring the second image by placing a second image capturing area of the subject S in the FOV of the objective lens unit 20.

There is no significant structural difference between the image acquisition device 100′ according to the second exemplary embodiment of the present disclosure and the image acquisition device 100 according to the first exemplary embodiment except that the image collection unit 10′ is not configured by the TDI sensor, but is configured by an area sensor. Accordingly, the same configuration as the image acquisition device 100 according to the first exemplary embodiment illustrated in FIGS. 1 and 2 will be denoted by the same reference numeral and a redundant description will be omitted.

Referring to FIG. 4, the image acquisition device 100′ according to the second exemplary embodiment of the present disclosure includes an image collection unit 10′ which is an area sensor including a variable focus lens.

The image collection unit 10′ allows the variable focus lens included in the area sensor to change the focal distance several times to tens of times during one exposure time to generate one image in which images of the subject S having various focal distances are added. At this time, the focal distance change by the variable focus lens may be continuously performed in the Z-axis direction illustrated in FIG. 4.

Referring to FIG. 5A and FIG. 5B, the process of acquiring an image using an image acquisition device 100′ according to the second exemplary embodiment of the present disclosure is as follows.

First, as illustrated in FIG. 5A, the area to be captured of the subject S (for example, a first image capturing area) is located in the FOV of the objective lens unit 20 according to the driving of the stage unit 30. At this time, the area to be captured may be designated by the user by means of a separate input interface connected to the image acquisition device 100′ according to the second exemplary embodiment and the stage unit 30 is driven according to the designated area to be captured using the input interface so that the area to be captured of the subject S is located in the FOV of the objective lens unit 20.

At this time, like the image acquisition device 100′ according to the exemplary embodiment of the present disclosure, when the image collection unit 10′ is configured by the area sensor, the FOV of the objective lens unit 20 may refer to a vertical viewing angle, a horizontal viewing angle, or a diagonal viewing angle of the scan direction.

Next, as illustrated in FIG. 5A, the focal position reception unit 50 receives a thickness of the subject S, the Z-axis height position of the subject S in the area to be captured, and a focal position of the objective lens unit 20. At this time, like the image acquisition device 100 according to the first exemplary embodiment, the thickness of the subject S input by the focal position reception unit 50 may be within 90% of the entire thickness of the subject S.

Next, as illustrated in FIG. 5A, in the area to be captured, an image in which the Z-axis signals are superposed within the range corresponding to the thickness of the subject S may be generated by the image collection unit 10′.

As illustrated in FIG. 4, when the image acquisition device 100′ of the second exemplary embodiment in which the image collection unit 10′ is configured by the area sensor is used, when the area sensor is exposed one time, the variable focus lens provided in the image collection unit 10′ continuously changes (for example, continuously quickly changes from a lowest height of the subject S to a highest height or from the highest height to the lowest height) the focal distance within a range corresponding to the thickness (for example, approximately 90% of the entire thickness of the subject S) of the subject S input by the focal position reception unit 50 to acquire different Z-axis signals and then blocks the exposure of the area sensor and summates different Z-axis signals to acquire an image in which different Z-axis signals are superposed.

However, before the exposure of the area sensor, in the image collection unit 10′, the variable focus lens starts changing of the focal distance and the exposure of the area sensor may begin while the variable focal lens changes the focal distance within the range corresponding to the thickness of the subject S.

Further, the thickness of the subject S which is input to the focal position reception unit 50 is not limited to the above description so that the thickness may be much smaller than 90% of the entire thickness of the subject S or may be 100% of the entire thickness of the subject S according to the characteristic of the subject S.

Accordingly, when the Z-axis signal values for different focus heights are summated by the image collection unit 10′, the image acquisition device 100′ of the second exemplary embodiment generates an image in which images with various focus heights are superposed.

Next, the low frequency removal filtering process may be performed on the image generated by the image collection unit 10′, by the filtering unit 62 provided in the image processing unit 60.

In the image acquisition method using the image acquisition device 100′ according to the second exemplary embodiment, similar to the image acquisition method using the image acquisition device 100 according to the first exemplary embodiment, when there is no area to be captured in the subject S other than the above-described area to be captured (for example, the first image capturing area in which the first image is captured), as described above, a separate image stitching process by the image matching unit 64 provided in the image processing unit 60 may not be performed. When there is no area to be captured of the subject S other than the first image capturing area, the image processing unit 60 stores the first image which is generated by the image collection unit 10′ and is subjected to the low frequency removal filtering process by the filtering unit 64 and the display unit 70 displays the generated first image to the user.

In the meantime, when there is another area to be captured in the subject S other than the above-described first image capturing area, as illustrated in FIG. 5B, the subject S moves according to the driving of the stage unit 30 to place the area to be captured of the subject S (a second image capturing area) adjacent to the first image capturing area in the FOV of the objective lens unit 20. For example, the second image capturing area may at least partially overlap the first image capturing area.

Similar to the first image capturing area, the second image capturing area is also designated by the user by means of the above-described input interface. As the second image capturing area is designated by the input interface, the stage unit 30 is driven to locate the second image capturing area of the subject S in the FOV of the objective lens unit 20.

Next, as illustrated in FIG. 5B, the Z-axis height position of the subject S in the second image capturing area may be input by the focal position reception unit 50.

Next, as illustrated in FIG. 5B, in the second image capturing area, a second image in which the Z-axis signals are superposed within the range corresponding to the thickness of the subject S may be generated by the image collection unit 10′.

At this time, the second image may be an image generated by superimposing images with various focus heights, similar to the above-described first image.

Next, the low frequency removal filtering process may be performed on the second image generated by the image collection unit 10′, by the filtering unit 62 provided in the image processing unit 60. The image acquisition method using the image acquisition device 100′ according to the exemplary embodiment of the present disclosure may be repeatedly performed until there is no more area adjacent to the first image capturing area and the second image capturing image or there is no area to be captured which has not been captured for the subject S (until the whole region of interest ROI of the subject S is captured).

Next, the first image and the second image are subjected to the stitching process by the image matching unit 64 provided in the image processing unit 60 to generate the whole slide image. As described above, the second image capturing area may at least partially overlap the first image capturing area so that when the image matching unit 64 stitches the first image and the second image, in order to remove the difference in the overlapping portion of the first image and the second image, the image matching unit 64 performs the stitching process by making colors, brightnesses, contrasts, and resolutions equal to each other in the overlapping portion of the first image and the second image as much as possible.

Next, the display unit 70 displays the whole slide image generated by stitching the first image and the second image by the image matching unit 64 to the user.

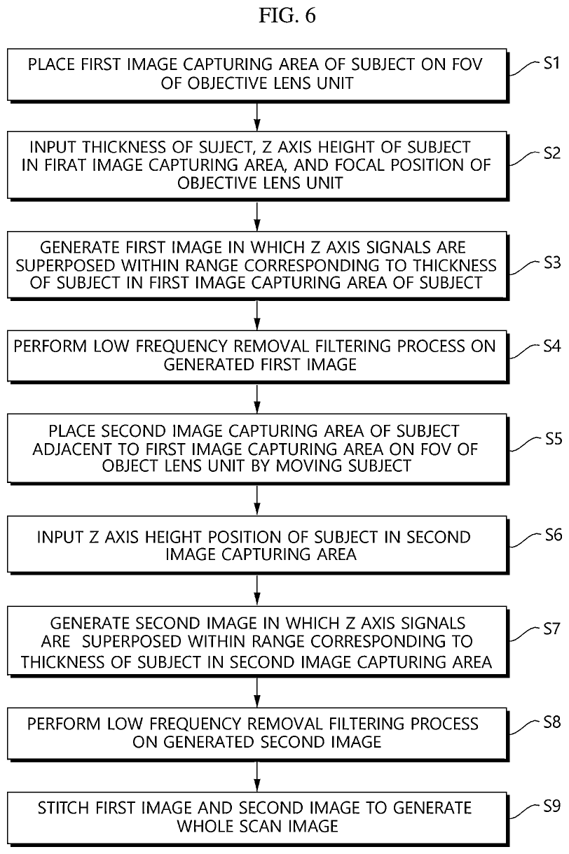

FIG. 6 is a flowchart illustrating an image acquisition method using an image acquisition device 100, 100′ according to the present disclosure.

As described above, the image acquisition method using the image acquisition device 100 according to the first exemplary embodiment of the present disclosure and the image acquisition device 100′ according to the second exemplary embodiment of the present disclosure has been described in detail so that the flowchart of FIG. 6 will be briefly described to be described below.

Referring to FIG. 6, the image acquisition method using an image acquisition device 100, 100′ according to the present disclosure is as follows.

First, as illustrated in FIGS. 3A and 5A, the first image capturing area of the subject S is located in the FOV of the objective lens unit 20 (step S1). At this time, the step S1 may be performed by the above-described driving of the stage unit 30.

Next, the thickness of the subject S, the Z-axis height position of the subject S in the first image capturing area, and a focal position of the objective lens unit 20 are input (step S2). At this time, the step S2 may be performed by the above-described focal position reception unit 50.

Even though in FIG. 6, it is illustrated that the step S2 is performed after the step S1, it is not limited thereto so that after performing the step S2, the step S1 may be performed.

After perform the steps S1 and S2, in the first image capturing area of the subject S, the first image in which the Z-axis signals are superposed within the range corresponding to the thickness of the subject S is generated (step S3). At this time, the step S3 is performed by the above-described image collection unit 10, 10′.

After the step S3, the low frequency removal filtering process is performed on the generated first image (step S4). At this time, the step S4 is performed by the filtering unit 62 provided in the above-described image processing unit 60.

In the image acquisition method using the image acquisition device 100, 100′ of the present disclosure, when there is no image capturing area for the subject S other than the above-described first image capturing area, the image processing unit 60 stores the generated first image and the display unit 70 displays the generated first image to the user.

When there is other image capturing area than the above-described first image capturing area, as illustrated in FIG. 3B or 5B, the subject S moves to place the second image capturing area of the subject S adjacent to the first image capturing area in the FOV of the objective lens unit 20 (step S5). At this time, the step S5 is performed by the above-described driving of the stage unit 30 and the second image capturing area may at least partially overlap the first image capturing area.

After the step S5, a Z-axis height position of the subject S in the second image capturing area is input (step S6). At this time, the step S6 is performed by the above-described focal position reception unit 50.

As described above, when there is other image capturing area than the above-described first image capturing area, the Z-axis height position input by the focal position reception unit 50 in steps S2 and S6 may be performed every time before capturing the first image or the second image or performed only before capturing the first image.

In the image acquisition method according to the present disclosure, a signal image in which various focus heights are superposed is generated as one image by the image collection unit 10, 10′ so that a detailed focus is not necessary to capture a raw image for each focus height. Therefore, even though the Z-axis height position is not always input by the focal position reception unit 60 before capturing the image by the image collection unit 10, 10′, a sufficiently focused high depth of field image may be acquired.

Accordingly, in the image acquisition method according to the present disclosure, the Z-axis height position is not always input by the focal position reception unit 60 before capturing the image by the image collection unit 10, 10′ so that the capturing speed may be increased.

When there is a plurality of areas to be captured of the subject S, other than the first image capturing area and the second image capturing area, the Z-axis height position is input by the above-described focal position reception unit 50 every time before capturing the image or only before capturing the first image, or once before capturing the image every predetermined number of times.

After the step S6, in the second image capturing area, a second image in which Z-axis signals are superposed within the range corresponding to the thickness of the subject S is generated (step S7). At this time, the step S7 is performed by the above-described image collection unit 10, 10′.

After the step S7, the low frequency removal filtering process is performed on the generated second image (step S8). At this time, the step S8 is performed by the filtering unit 62 provided in the above-described image processing unit 60.

The image acquisition method using the image acquisition device 100, 100′ according to the present disclosure may be repeatedly performed until there is no more area adjacent to the first image capturing area and the second image capturing image or there is no area to be captured which has not been captured for the subject S.

After the step S8, the first image and the second image are stitched to generate the whole slide image (step S9). At this time, the step S9 is performed by the image matching unit 64 provided in the above-described image processing unit 60.

Next, the display unit 70 displays the whole slide image generated by stitching the first image and the second image by the image matching unit 64 to the user.

In the meantime, in the above-described image acquisition method of the present disclosure, as described in steps S4 and S8, it has been described that the low frequency removal filtering process is performed by the filtering unit 62 after generating the image by superimposing the Z-axis signals, it is not limited thereto.

To be more specific, in the image acquisition method of the present disclosure, (i) the low frequency removal filtering process is performed after capturing the image in the area to be captured as described in steps S4 and S8, (ii) after capturing all the regions of interest ROI of the subject S, before matching the images by the image matching unit 64, the low frequency removal filtering process is performed, (iii) after capturing all the regions of interest ROI of the subject S, and matching the images by the image matching unit 64, the low frequency removal filtering process is performed, or (iv) the low frequency removal filtering process is performed whenever a predetermined part of the subject S is captured.

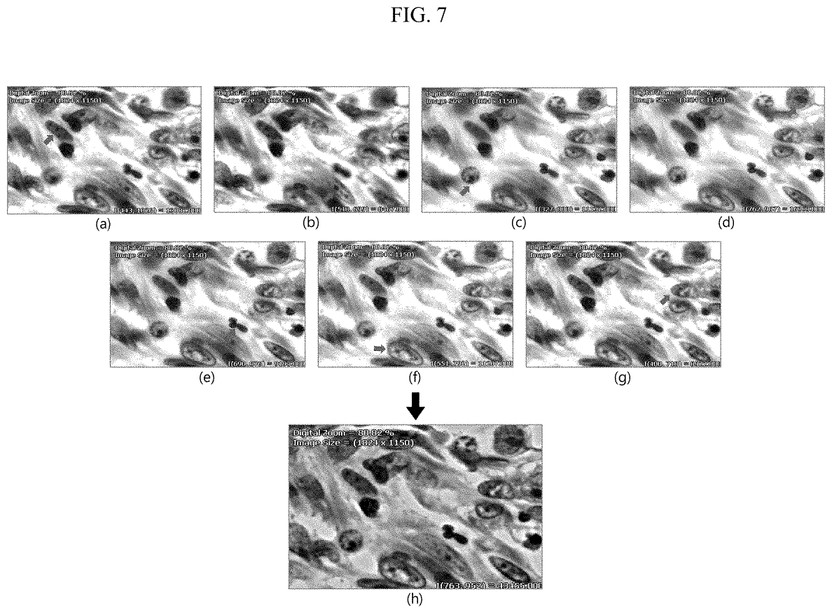

FIG. 7 is a view illustrating an example of an image acquired using an image acquisition device 100, 100′ according to the present disclosure.

A Z-axis raw image (see FIGS. 7A to 7G) illustrated in FIG. 7 is an image captured by a method of capturing a plurality of Z-axis signal images by adjusting a focus height of the objective lens unit and a plurality of raw images having image information about different Z-axis heights is illustrated.

A Z-axis information superposed image illustrated in FIG. 7 (see FIG. 7H) is an image obtained by generating one image in which various Z-axis signals are superposed by a method proposed by the present disclosure to apply the low frequency removal filter and is an example illustrating a state in which in step S4 or S8, the low frequency removal filter is applied to the first image or the second image generated by superimposing the Z-axis signals.

Referring to Z-axis information superposed image of FIG. 7, it is confirmed that the Z-axis information superposed image is acquired by combining an area of each Z-axis raw image which is well focused (a portion denoted by an arrow in FIGS. 7A to 7G) as one image.

According to the present disclosure, Z-axis image information is acquired to be superposed as a single image to acquire a high depth of field image while reducing a scanning time and simplifying a data quantity and an image processing amount.

The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present invention do not limit the technical spirit of the present invention and the scope of the technical spirit is not limited by the exemplary embodiments and accompanying drawings. The protective scope of the present disclosure should be construed based on the following claims, and all the technical concepts in the equivalent scope thereof should be construed as falling within the scope of the present disclosure.

What is claimed is:

1. An image acquisition device which acquires an image of a subject, comprising:
an image collection unit; and
an objective lens unit disposed below the image collection unit,
wherein the image collection unit generates an image in which Z-axis signals are superposed within a range corresponding to a thickness of the subject, in an area to be captured of the subject.

2. The image acquisition device according to claim 1, wherein the area to be captured includes a first image capturing area in which the first image is captured and a second image capturing area which is an area to be captured of the subject adjacent to the first image capturing area, the image collection unit is configured to generate a first image in which the Z-axis signals are superposed within the range corresponding to the thickness of the subject in the first image capturing area and generate a second image in which the Z-axis signals are superposed within the range corresponding to the thickness of the subject in the second image capturing area.

3. The image acquisition device according to claim 2, further comprising:
a Z-axis position reception unit which receives a thickness of the subject, a Z-axis height position in the area to be captured, and a focal position of the objective lens unit;
an image processing unit which matches the first image and the second image to generate a whole slide image; and
a display unit which outputs the generated whole slide image.

4. The image acquisition device according to claim 1, wherein the image collection unit is a TDI sensor including a plurality of stages.

5. The image acquisition device according to claim 4, wherein the image collection unit is disposed with respect to the subject such that the plurality of stages is inclined with respect to a movement direction of the subject at a predetermined angle and is configured to continuously acquire different Z-axis signals formed at different focus heights in each stage within the range corresponding to the thickness of the subject and acquire the image in which the Z-axis signals are superposed by summating the different Z-axis signals for each stage.

6. The image acquisition device according to claim 1, wherein the image collection unit is an area sensor including a variable focus lens.

7. The image acquisition device according to claim 6, wherein the image collection unit is configured to allow the variable focus lens to continuously change a focal distance within the range corresponding to the thickness of the subject to acquire different Z-axis signals and summate the different Z-axis signals to acquire the image in which Z-axis signals are superposed.

8. The image acquisition device according to claim 1, further comprising:
an image processing unit including a filtering unit which performs a low frequency removal filtering process on the image in which the Z-axis signals are superposed.

9. The image acquisition device according to claim 3, wherein the image processing unit includes:
a filtering unit which performs a low frequency removal filtering process on the first image and the second image; and
an image matching unit which stitches the first image and the second image which are subjected to the low frequency removal filtering process to generate the whole slide image.

10. The image acquisition device according to claim 1, further comprising:
a stage unit which is disposed below the objective lens unit and on which the subject is disposed; and
an illumination unit which is disposed below the stage unit and irradiates a light onto the subject.

11. The image acquisition device according to claim 2, wherein the second image at least partially overlaps the first image.

12. An image acquisition method, comprising:
placing a first image capturing area of a subject on an FOV of an objective lens unit;
receiving a thickness of the subject, a Z-axis height position of the subject in the first image capturing area, and a focal position of the objective lens unit;
generating a first image in which Z-axis signals are superposed within a range corresponding to the thickness of the subject in the first image capturing area; and
performing a low frequency removal filtering process on the generated first image.

13. The image acquisition method according to claim 12, further comprising:
placing a second image capturing area of the subject adjacent to the first image capturing area on an FOV of the objective lens unit by moving the subject;
receiving a Z-axis height position of the subject in the second image capturing area;
generating a second image in which Z-axis signals are superposed within the range corresponding to the thickness of the subject in the second image capturing area;
performing a low frequency removal filtering process on the generated second image; and
generating a whole slide image by stitching the first image and the second image.

14. The image acquisition method according to claim 13, wherein the second image at least partially overlaps the first image.
